(19) United States
(12) Patent Application Publication
(10) Pub. No.: US 2019/0061503 A1
(43) Pub. Date: Feb. 28, 2019

(54) OUTER BELT MOLDING DESIGN FOR HIDDEN FLANGE DOOR

(71) Applicants: GM GLOBAL TECHNOLOGY OPERATIONS LLC, Detroit, MI (US); Cooper Standard Automotive Inc., Novi, MI (US)

(72) Inventors: Larry A. Filipczak, West Bloomfield, MI (US); Robert Conner, Lennox, MI (US); Brian W. Geib, Rochester Hills, MI (US)

(73) Assignees: GM GLOBAL TECHNOLOGY OPERATIONS LLC, Detroit, MI (US); Cooper Standard Automotive Inc., Novi, MI (US)

(21) Appl. No.: 15/688,410

(22) Filed: Aug. 28, 2017

(51) Int. Cl. B60J 10/75; B60J 1/20; B60J 10/25; B60J 10/15

(52) U.S. Cl. CPC B60J 10/75; B60J 10/15; B60J 10/25; B60J 1/2097

(57) ABSTRACT

An outer belt molding can be used in a vehicle and includes a molding body having a first body end and a second body end opposite the first body end. The outer belt molding also includes an anti-glass-rattle bumper disposed at the second body end of the molding body. Further, the outer belt molding includes a window sealing arm coupled to the molding body and a body sealing arm coupled to the window sealing arm and extending toward the molding body. The outer belt molding further includes a connecting arm coupled to the molding body and a securing arm coupled to the connecting arm. The securing arm is parallel to the molding body.

### BACKGROUND

Outer belt molding is generally used to provide a water-resistant seal between a vehicle door and a window pane that is translatable relative to the door. Belt moldings may generally be configured to channel rain-water and/or exterior liquids away from electronics or other hardware within the door assembly. Additionally, such moldings may channel such exterior liquids away from the window to prevent the window from freezing to the molding in cold weather climates.

### SUMMARY

The presently disclosed outer belt molding is designed to work on any multi-purpose door construction with a low-profile style of outer belt or fully hidden (no visible molding) execution. Thus, the outer belt molding can be configured as a hidden belt molding design with nothing visible below the beltline (i.e., below the uppermost part of an outer body panel of a vehicle door assembly). This outer belt molding can be used with a magnesium door reinforcement panel, but it also has other applications. Further, this outer belt molding does not rely on metal clips for retention and/or locating. Further, this outer belt molding includes a substantially h-shaped carrier that strengthens the outer belt molding, thereby preventing bending and twisting during handling. Because of its shape, the outer belt molding can be easily installed.

The outer belt molding can be used in a vehicle and includes a molding body having a first body end and a second body end opposite the first body end. The outer belt molding also includes an anti-glass-rattle bumper disposed at the second body end of the molding body. Further, the outer belt molding includes a window sealing arm compliantly coupled to the molding body and a body sealing arm compliantly coupled to the window sealing arm and extending toward the molding body. The outer belt molding further includes a connecting arm coupled to the molding body and a securing arm coupled to the connecting arm. The securing arm is parallel to the molding body. The outer belt molding also includes a carrier disposed at least inside the molding body. The carrier is wholly or partly made of a metallic material. The carrier includes a first carrier portion disposed inside the molding body and a second carrier portion disposed inside the securing arm. The first carrier portion is parallel to the second carrier portion. The carrier includes a third carrier portion interconnecting the first carrier portion and the second carrier portion. The third carrier portion is disposed inside the connecting arm. The molding body, the securing arm, and the connecting arm are wholly or partly made of a polymeric material. The outer belt molding further includes an extension connected at the first end of the molding body. The extension is obliquely angled relative to the molding body. The carrier includes a fourth carrier portion disposed inside the extension. The fourth carrier portion is coupled to the first carrier portion. The fourth carrier portion is obliquely angled relative to the first carrier portion. The outer belt molding further includes a cap directly coupled to the extension. The carrier includes a fifth carrier portion disposed inside the cap. The fifth carrier portion is directly coupled to the fourth carrier portion, and the fifth carrier portion is obliquely angled relative to the fourth carrier portion.

The present disclosure also describes a vehicle door assembly. The vehicle door assembly further includes an outer body panel defining an inner panel surface and an outer panel surface opposite the inner panel surface and a flange coupled to the outer body panel. The flange is closer to the inner panel surface than to the outer surface of the outer body panel. The vehicle door assembly further includes an outer belt molding coupled to the flange. The outer belt molding includes a molding body having a first body end and a second body end opposite the first body end. The outer belt molding further includes an anti-glass-rattle bumper disposed at the second body end of the molding body. The outer belt molding further includes a window sealing arm compliantly coupled to the molding body and a body sealing arm compliantly coupled to the window sealing arm and extending toward the molding body.

The outer belt molding further includes a connecting arm coupled to the molding body and a securing arm interconnecting the connecting arm and the molding body. The securing arm is parallel to the molding body. A carrier is disposed at least inside the molding body and may be made of a metallic material. The carrier includes a first carrier portion disposed inside the molding body and a second carrier portion disposed inside the securing arm. The first carrier portion is parallel to the second carrier portion. The carrier portion includes a third carrier portion interconnecting the first carrier portion and the second carrier portion. The third carrier portion is disposed inside the connecting arm. The third carrier portion may be perpendicular to the first carrier portion. The third carrier portion may be perpendicular to the second carrier portion. The molding body, the securing arm, and the connecting arm may be wholly or partly made of a polymeric material. The outer belt molding may further include an extension connected at the first end of the molding body. The extension is obliquely angled relative to the molding body. The carrier includes a fourth carrier portion disposed inside the extension, the fourth carrier extension is coupled to the first carrier portion. The fourth carrier portion is obliquely angled relative to the first carrier portion. The molding body is spaced apart from the securing arm to define an open cavity. The open cavity receives the flange. The flange is part of a reinforcement panel. The reinforcement panel may be made of magnesium. The reinforcement panel includes a main panel body. The reinforcement panel further includes at least one bonding pad. The vehicle door assembly further includes adhesive between the bonding pad and the outer body panel to couple the reinforcement panel to the outer body panel. The outer belt molding further includes a cap directly coupled to the extension. The carrier includes a fifth carrier portion disposed inside the cap. The fifth carrier portion is directly coupled to the fourth carrier portion. The fifth carrier portion is obliquely angled relative to the fourth carrier portion. The vehicle door assembly further includes an inner body panel. The reinforcement panel is closer to the outer body panel than to the inner body panel. The reinforcement panel includes a horizontal panel portion interconnecting the flange and the main panel body, and the flange is obliquely angled relative to the horizontal panel. The vehicle door assembly is characterized by an absence of a clip coupling the outer belt molding to the reinforcement panel. The outer belt molding further includes a plurality of gripers extending directly from the securing arm toward the molding body. The grippers are in direct contact with the flange to secure the outer belt molding to the flange. The cap is in direct contact with the outer body panel to secure the outer belt molding to the outer body panel. The molding body is in direct contact with the flange to secure the flange to the outer belt molding. The flange defines an outer flange surface and an inner flange surface opposite the outer flange surface. The outer flange surface is closer to the outer body panel than the inner flange surface. The grippers are in direct contact with the outer flange surface, and the molding body is in direct contact with the inner flange surface.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic perspective view of a vehicle including a vehicle door assembly.

FIG. 2 is a schematic cross-sectional view of a portion of a vehicle door assembly.

FIG. 3 is an isometric top view of the vehicle door assembly.

FIG. 4 is an isometric view of an outer belt molding of the vehicle door assembly.

FIG. 5 is a cross-sectional view of an outer belt molding.

### DETAILED DESCRIPTION

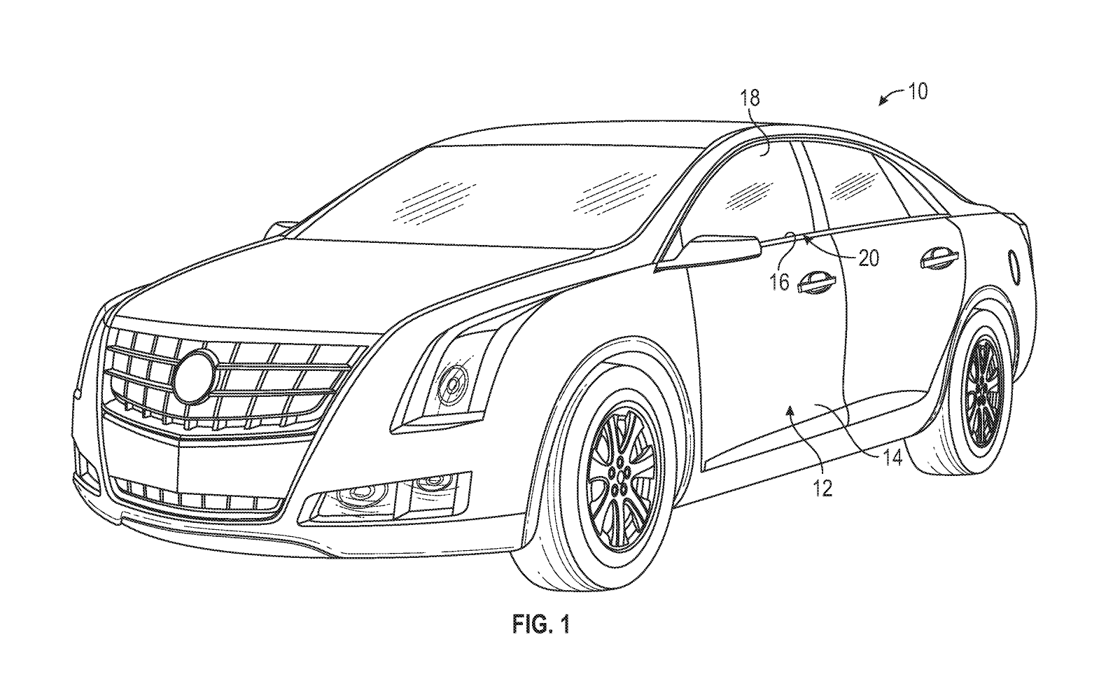

Referring to the drawings, wherein like reference numerals are used to identify like or identical components in the various views, FIG. 1 schematically illustrates a vehicle 10 having at least one vehicle door assembly 12. The vehicle door assembly 12 generally includes at least one outer body panel 14, and at least partially defines a window opening 16. A movable window pane 18 may be in mechanical communication with the vehicle door assembly 12, and may selectively transition between a closed state (as shown) and an open state. In the closed state, the window opening 16 may generally be blocked by the window pane 18, while in the open state at least a portion of the window opening 16 may be open or unobstructed. The transition between open and closed may be accomplished by retracting the window pane 18 into the vehicle door assembly 12 through a window slot provided on the lower edge of the window opening 16, where the slot is at least partially defined by the outer body panel 14.

As will be discussed in more detail below, an outer belt molding 20 may be coupled with the vehicle door assembly 12 and may be adapted to generally inhibit water or other moisture from entering the vehicle door assembly 12 adjacent to the window pane 18. Said another way, the outer belt molding 20 may generally seal the opening between the outer body panel 14 and the window pane 18.

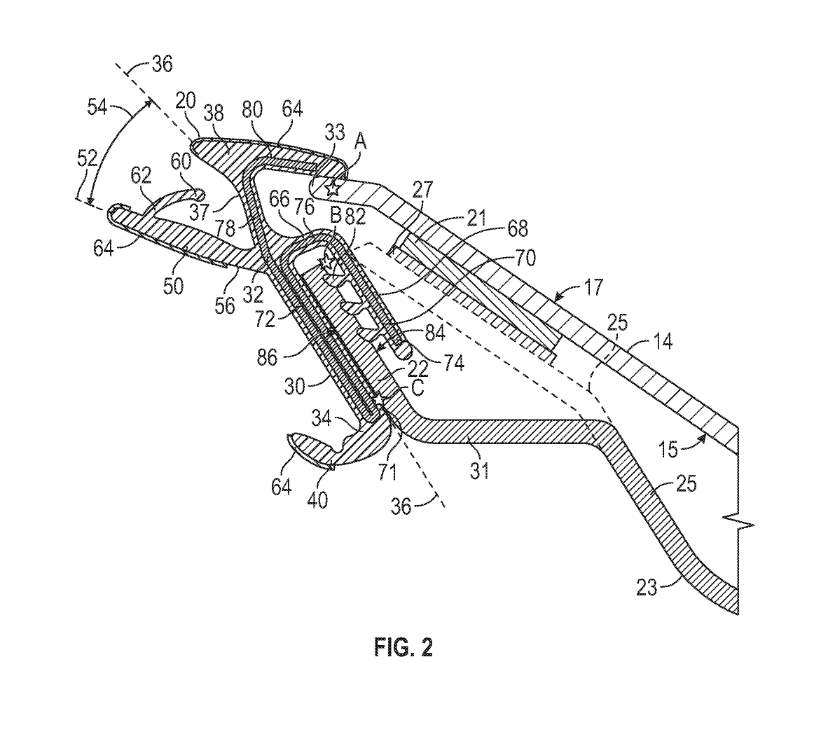

FIG. 2 schematically illustrates an embodiment of the outer belt molding 20 being held against the outer body panel 14 of the vehicle door assembly 12, while being secured to a flange 22 without using clips. The flange 22 may be wholly or partly made of magnesium. Metal clips should not be used when the flange 22 is made of magnesium to prevent (or at least minimize) corrosion. Alternatively, both the outer body panel 14 and the flange 22 may be formed from a sheet molded compound (SMC) that may, for example, include a fiber-reinforced polyester. Alternatively, the outer body panel 14 and/or flange 22 may be formed from a stamped sheet metal, such as, for example, aluminum or steel.

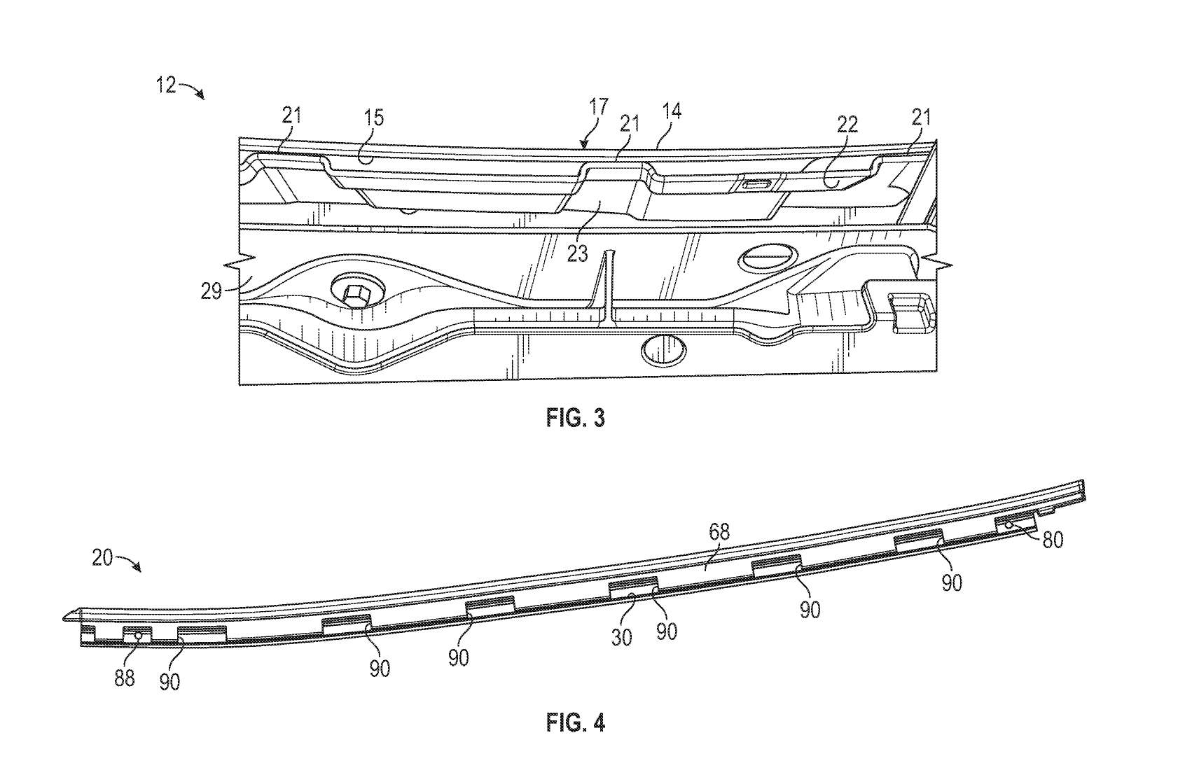

With reference to FIGS. 2 and 3, the flange 22 may be located inwardly relative to the outer body panel 14, and may be secured to the outer body panel 14 through the use of an adhesive 21 and/or one or more screws, bolts, rivets, and/or welds. In one configuration, the flange 22 may serve to reinforce the outer body panel 14 from deflecting into/out and/or up/down relative to the vehicle door assembly 12. The outer body panel 14 defines an inner panel surface 15 and an outer panel surface 17 opposite the inner panel surface 15. The flange 22 may be closer to the inner panel surface 15 than to the outer panel surface 17 of the outer body panel 14 to inhibit the outer body panel 14 from deflecting inwardly. The flange 22 is part of a reinforcement panel 23. The reinforcement panel 23 may be wholly or partly made of magnesium and includes a main panel body 25 coupled to the flange 22. The reinforcement panel 23 further includes a plurality of bonding pads 27 mounted on the main panel body 25. Adhesive 21 is disposed between the bonding pads 27 and the outer body panel 14 to couple the reinforcement panel 23 to the outer body panel 14.

The vehicle door assembly 12 further includes an inner body panel 29 coupled to the outer body panel 14. The reinforcement panel 23 is closer to the outer body panel 14 than to the inner body panel 29 to prevent the outer body panel 14 from deflecting inwardly toward the passenger compartment of the vehicle 10. The reinforcement panel 23 includes a horizontal panel portion 31 directly interconnecting the flange 22 and the main panel body 25. The flange 22 is obliquely angled relative to the horizontal panel portion 31 to allow most of the outer belt molding 20 to be disposed below the uppermost part 33 of the outer body panel 14 (i.e., below the beltline), thereby allowing the outer belt molding to have a low profile. As discussed above, the vehicle door assembly 12 is characterized by an absence of one or more clips coupling the outer belt molding 20 to the reinforcement panel 23, thereby minimizing part count.

With reference to FIGS. 2, 4, and 5, when the outer belt molding 20 is assembled in the vehicle door assembly 12, the outer belt molding 20 is configured to contact the window pane 18 (FIG. 1). The outer belt molding 20 includes a molding body 30 defining a first body end 32 and a second body end 34 opposite the first body end 32. The molding body 30 may be elongated and, therefore, may generally be oriented along a body axis 36 (i.e., defined in the cross-sectional view). The outer belt molding 20 further includes an extension 37 directly connected to the first body end 32 of the molding body 30. A cap 38 is directly coupled to the extension 37. The extension 37 is obliquely angled relative to the molding body 30 to allow the cap 38 to rest on (and be in direct contact with) the outer body panel 14, thereby enhancing the structural stability of the vehicle door assembly 12. An anti-glass-rattle bumper 40 may be directly coupled to the second end 34 of the molding body 30, and may generally extend out from the molding body 30 toward the window pane 18 (i.e., away from the body axis 36).

A window sealing arm 50 may be compliantly coupled to the molding body 30 of the outer belt molding 20 directly at the first body end 32. The window sealing arm 50 may be generally situated along an arm axis 52 that may be at an angle 54 to the body axis 36 of the molding body 30. In one embodiment, the angle 54 formed by the window sealing arm 50 and the first body end 32 of the molding body 30 may be an acute angle.

The interface between the window sealing arm 50 and molding body 30 of the outer belt molding 20 may include a first compliant joint 56 that may permit the window sealing arm 50 to elastically pivot about the first compliant joint 56. In one configuration, the first compliant joint 56 may include a portion of the window sealing arm 50 that is narrower than the remainder of the arm to facilitate localized bending. In this manner, a transverse load applied to the window sealing arm 50 may cause an angular elastic strain to occur predominantly at the narrowed portion of the first compliant joint 56.

A body sealing arm 60 may be compliantly coupled to the window sealing arm 50, and may extend outward from the window sealing arm 50 in a direction generally toward the molding body 30 of the outer belt molding 20. The body sealing arm 60 may be generally articulable about a second compliant joint 62 at the base of the body sealing arm 60. When a surface of the window sealing arm 50 makes contact with the window pane 18, the window pane 18 may urge the window sealing arm 50 to articulate about the first compliant joint 56 toward the cap 38. During this motion, the body sealing arm 60 may contact the molding body 30 of the outer belt molding 20, which may urge the body sealing arm 60 to generally articulate about the second compliant joint 62 toward the window sealing arm 50. While rotating, the body sealing arm 60 may remain in contact with the molding body 30, and may impede liquid from flowing between window sealing arm 50 and the molding body 30, toward the first compliant joint 56.

The outer belt molding 20 further includes a connecting arm 66 coupled to the molding body 30 directly at the first body end 32. In addition, the outer belt molding 20 includes a securing arm coupled to the connecting arm 66. The securing arm 68 is parallel to the molding body 30 to allow the flange 22 to be securely disposed between the securing arm 68 and the molding body 30. The molding body 30 is spaced apart from the securing arm 68 to define an open cavity 71. The open cavity 71 receives the flange 22 to secure the flange 22 to the outer belt molding 20.

The molding body 30, the securing arm 68, and the connecting arm 66, the extension 37, and the cap 38 are wholly or partly made of a polymeric material that may have suitable characteristics to promote sealing between the various components. For example, the molding 20 may be made from a polypropylene material. Alternatively, the outer belt molding 20 may be made from a thermoplastic elastomer (TPE), thermoplastic vulcanizate (TPV), a vulcanized rubber material (EPDM) or any other similar material. In one configuration, the molding body 30 may be constructed from a polymeric material having a different hardness than the window sealing arm 50 (and body sealing arm 60) and/or anti-glass-rattle bumper 40. For example, the cap 38 and molding body 30 of the outer belt molding 20 may have a durometer value of approximately 75-90 on the Shore-A scale (measured according to ASTM standard D2240). Conversely, the window sealing arm 50 (and body sealing arm 60) and/or the anti-glass-rattle bumper 40 may have a durometer value of approximately 60-70 on the Shore-A scale. By fabricating the cap 38 and molding body 30 from a harder durometer material, it may provide increased structural rigidity to the outer belt molding 20, while the softer window sealing arm 50 and/or anti-glass-rattle bumper 40 may be more configured for compliant contact with the window pane 18.

A portion of the window sealing arm 50, the cap 38, and/or the anti-glass-rattle bumper 40 may be covered with a flock material 64 to dampen the contact interface with the window pane 18 and/or provide aesthetic qualities. The flock material 64 may be a polyester, nylon, or acrylic flock, and may generally be adhered to the surface of the window sealing arm 50/anti-glass-rattle bumper 40 using a suitable adhesive. The flock material 64 may permit the window pane 18 to freely slide against the outer belt molding 20 without any undesirable amount of contact friction (i.e., the flock material 64 may reduce the coefficient of static and/or dynamic friction between the window pane 18 and the outer belt molding 20).

A carrier 70 may be disposed within the molding body 30. The carrier 70 may be wholly or partly made of a metallic material (e.g., aluminum), or may be formed from a sufficiently hard polymer to further enhance the structural rigidity of the outer belt molding 20 to resist buckling during installation and/or torsional deflection during use. As illustrated, the carrier 70 may partially extend within the cap 38 for reinforcement. The carrier 70 includes a first carrier portion 72 disposed inside the molding body 30. The first carrier portion 72 may be entirely encapsulated by the polymeric material forming the molding body 30 to inhibit corrosion when the flange 22 is wholly or partly made of magnesium. The first carrier portion 72 may be U-shaped to enhance its structural integrity. The carrier 70 includes a second carrier portion 74 coupled to the first carrier portion 72 and disposed inside the securing arm 68. The first carrier portion 72 is parallel to the second carrier portion 74 to facilitate the connection between the outer belt molding 20 and the flange 22. The carrier 70 includes a third carrier portion 76 directly interconnecting the first carrier portion 72 and the second carrier portion 74 to enhance the structural integrity of the carrier 70. In particular, the third carrier portion 76 is directly coupled to the first carrier portion 72 and is also directly coupled to the second carrier portion 74. Further, the third carrier portion 76 is perpendicular to the first carrier portion 72 and the second carrier portion 74 to facilitate the connection between the outer belt molding 20 and the flange 22. The third carrier portion 76 may be entirely encapsulated by the polymeric material forming the connecting arm 66 to minimize corrosion. The carrier 70 includes a fourth carrier portion 78 disposed inside the extension 37. For example, the fourth carrier portion 78 may be entirely encapsulated by the polymeric material forming the extension 37 to minimize corrosion and/or isolate non-compatible materials. The fourth carrier portion 78 may be directly coupled to the first carrier portion 72 to enhance the structural integrity of the carrier 70. The fourth carrier portion 78 is obliquely angled relative to the first carrier portion 72.

The carrier 70 includes a fifth carrier portion 80 disposed inside the cap 38. For example, the fifth carrier portion 80 may be entirely encapsulated by the polymeric material forming the cap 38 to minimize corrosion. The fifth carrier portion 80 is directly coupled to the fourth carrier portion 78 to enhance the structural integrity of the carrier 70. The fifth carrier portion 80 is obliquely angled relative to the fourth carrier portion 78 to allow easy accommodation within the cap 38.

The outer belt molding 20 further includes a plurality of grippers 82 extending directly from the securing arm 68 toward the molding body 30. The grippers 82 are in direct contact with the flange 22 to secure the outer belt molding 20 to the flange 22. The cap 38 is direct contact with the outer body panel 14 to secure the outer belt molding 20 to the outer body panel 14. The molding body 30 is direct contact with the flange 22 to secure the flange 22 to the outer belt molding 20. The flange 22 defines an outer flange surface 84 and an inner flange surface 86 opposite the outer flange surface 84. The outer flange surface 84 is closer to the outer body panel 14 than the outer flange surface 84. The grippers 82 are in direct contact with the outer flange surface 84, and the molding body 30 is in direct contact with the inner flange surface 86 to secure the outer belt molding 20 to the flange 22. As shown in FIG. 4, the outer belt molding 20 may include mounting holes 88 and notches 90 to facilitate the connection to the reinforcement panel 23 or of the reinforcement panel 23 to another component. When the outer belt molding 20 is mounted to the flange 22, the acting forces are balanced at points A, B, and C, thereby providing stability of the seal/molding assembly to the vehicle door assembly 12.

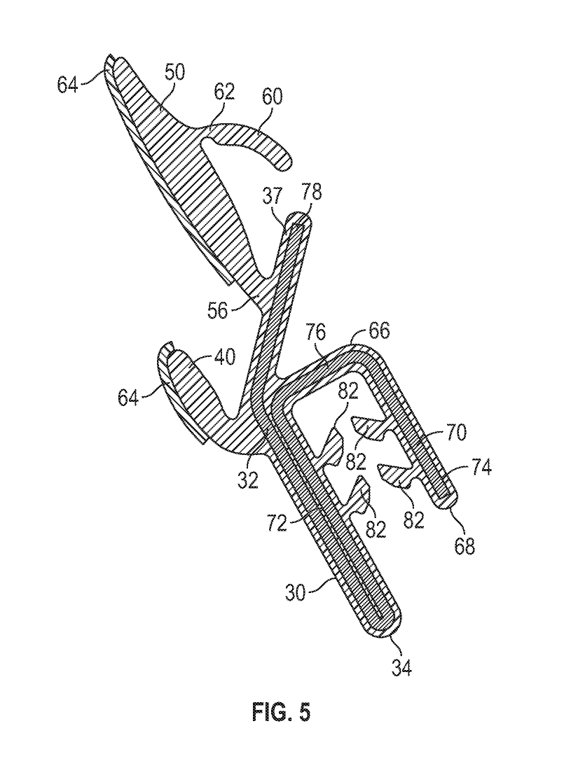

With reference to FIG. 5, in certain embodiments, the outer belt molding 20 does not include a cap 38. Specifically, the structure and functions of the embodiment shown in FIG. 5 is identical (or at least substantially similar) to the embodiment shown in FIG. 2, except for the features described below. In this embodiment, the outer belt molding 20 does not include a cap 38, and the carrier 70 does not include a fifth carrier portion 80. As result, the outer belt molding 20 is essentially a no-profile molding, because no portion of the outer belt molding 20 would be above the beltline (i.e., above the uppermost part of the outer body panel 14). The anti-glass-rattle bumper 40 is directly coupled to the first body end 32 of the molding body 30, and the window sealing arm 50 is directly coupled to the extension 37. In this embodiment, grippers 82 also protrude from the molding body 30 toward the securing arm 68.

While the best modes for carrying out the disclosure have been described in detail, those familiar with the art to which this disclosure relates will recognize various alternative designs and embodiments for practicing the disclosure within the scope of the appended claims. It is intended that all matter contained in the above description or shown in the accompanying drawings shall be interpreted as illustrative only and not as limiting.

1. An outer belt molding for a vehicle comprising:
a molding body having a first body end and a second body end opposite the first body end;
an anti-glass-rattle bumper disposed at the second body end of the molding body;
a window sealing arm coupled to the molding body;
a body sealing arm coupled to the window sealing arm and extending toward the molding body;
a connecting arm coupled to the molding body; and
a securing arm coupled to the connecting arm, wherein the securing arm is parallel to the molding body.

2. The outer belt molding of claim 1, further comprising a carrier disposed at least inside the molding body, wherein the carrier comprises a metallic material.

3. The outer belt molding of claim 2, wherein the carrier includes a first carrier portion disposed inside the molding body, and the carrier includes a second carrier portion disposed inside the securing arm.

4. The outer belt molding of claim 3, wherein the first carrier portion is parallel to the second carrier portion.

5. The outer belt molding of claim 4, wherein the carrier includes a third carrier portion interconnecting the first carrier portion and the second carrier portion, and the third carrier portion is disposed inside the connecting arm.

6. The outer belt molding of claim 5, wherein the molding body, the securing arm, and the connecting arm comprise a polymeric material.

7. The outer belt molding of claim 6, further comprising an extension connected at the first body end of the molding body, wherein the extension is obliquely angled relative to the molding body.

8. The outer belt molding of claim 7, wherein the carrier includes a fourth carrier portion disposed inside the extension, the fourth carrier portion is coupled to the first carrier portion, and the fourth carrier portion is obliquely angled relative to the first carrier portion.

9. The outer belt molding of claim 8, further comprising a cap directly coupled to the extension.

10. The outer belt molding of claim 9, wherein the carrier includes a fifth carrier portion disposed inside the cap, wherein the fifth carrier portion is directly coupled to the fourth carrier portion, and the fifth carrier portion is obliquely angled relative to the fourth carrier portion.

11. A vehicle door assembly comprising:
an outer body panel defining an inner panel surface and an outer panel surface opposite the inner panel surface;
a flange coupled to the outer body panel, wherein the flange is closer to the inner panel surface than to the outer panel surface of the outer body panel;
an outer belt molding coupled to the flange, wherein the outer belt molding includes:
a molding body having a first body end and a second body end opposite the first body end;
an anti-glass-rattle bumper disposed at the second body end of the molding body;
a window sealing arm coupled to the molding body;
a body sealing arm coupled to the window sealing arm and extending toward the molding body;
a connecting arm coupled to the molding body; and
a securing arm interconnecting the connecting arm and the molding body, wherein the securing arm is parallel to the molding body.

12. The vehicle door assembly of claim 11, further comprising a carrier disposed at least inside the molding body, wherein the carrier comprises a metallic material.

13. The vehicle door assembly of claim 12, wherein the carrier includes a first carrier portion disposed inside the molding body, and the carrier includes a second carrier portion disposed inside the securing arm.

14. The vehicle door assembly of claim 13, wherein the first carrier portion is parallel to the second carrier portion.

15. The vehicle door assembly of claim 14, wherein the carrier includes a third carrier portion interconnecting the first carrier portion and the second carrier portion, the third carrier portion is disposed inside the connecting arm, the third carrier portion is perpendicular to the first carrier portion, and the third carrier portion is perpendicular to the second carrier portion.

16. The vehicle door assembly of claim 15, wherein the molding body, the securing arm, and the connecting arm comprise a polymeric material.

17. The vehicle door assembly of claim 16, further comprising an extension connected at the first body end of the molding body, wherein the extension is obliquely angled relative to the molding body.

18. The vehicle door assembly of claim 17, wherein the carrier includes a fourth carrier portion disposed inside the extension, the fourth carrier portion is coupled to the first carrier portion, and the fourth carrier portion is obliquely angled relative to the first carrier portion, the molding body is spaced apart from the securing arm to define an open cavity, the open cavity receives the flange, the flange is part of a reinforcement panel, the reinforcement panel further includes magnesium, the reinforcement panel includes a main panel body, the reinforcement panel further includes at least one bonding pad, and the vehicle door assembly further includes an adhesive between the at least one bonding pad and the outer body panel to couple the reinforcement panel to the outer body panel.

19. The vehicle door assembly of claim 18, further comprising a cap directly coupled to the extension.

20. The vehicle door assembly of claim 19, wherein the carrier includes a fifth carrier portion disposed inside the cap, wherein the fifth carrier portion is directly coupled to the fourth carrier portion, the fifth carrier portion is obliquely angled relative to the fourth carrier portion, the vehicle door assembly further includes an inner body panel, the reinforcement panel is closer to the outer body panel than to the inner body panel, the reinforcement panel includes a horizontal panel portion interconnecting the flange and the main panel body, and the flange is obliquely angled relative to the horizontal panel portion, the vehicle door assembly is characterized by an absence of a clip coupling the outer belt molding to the reinforcement panel, the outer belt molding further includes a plurality of grippers extending directly from the securing arm toward the molding body, the grippers are in direct contact with the flange to secure the outer belt molding to the flange, the cap is in direct contact with the outer body panel to secure the outer belt molding to the outer body panel, and the molding body is in direct contact with the flange to secure the flange to the outer belt molding, the flange defines an outer flange surface and an inner flange surface opposite the outer flange surface, the outer flange surface is closer to the outer body panel than the inner flange surface, the grippers are in direct contact with the outer flange surface, and the molding body is in direct contact with the inner flange surface.
